(19) United States
(12) Patent Application Publication
(10) Pub. No.: US 2024/0372259 A1
(43) Pub. Date: Nov. 7, 2024

(54) ANTENNA DEVICE AND METHOD FOR MANUFACTURING ANTENNA DEVICE

(71) Applicant: Mitsubishi Electric Corporation, Tokyo (JP)

(72) Inventors: Takuma NISHIMURA, Tokyo (JP); Toru TAKAHASHI, Tokyo (JP); Hidenori ISHIBASHI, Tokyo (JP); Toru FUKASAWA, Tokyo (JP); Shinya YOKOMIZO, Tokyo (JP); Hidenori YUKAWA, Tokyo (JP)

(73) Assignee: Mitsubishi Electric Corporation, Tokyo (JP)

(21) Appl. No.: 18/775,667

(22) Filed: Jul. 17, 2024

Related U.S. Application Data
(63) Continuation of application No. PCT/JP2022/006288, filed on Feb. 17, 2022.

(51) Int. Cl. H01Q 9/04; H01Q 1/22

(52) U.S. Cl. CPC H01Q 9/0414; H01Q 1/2283

(57) ABSTRACT

An antenna device includes an antenna excitation element provided on a surface of a substrate, a conductor pattern provided on the surface of the substrate and disposed around the antenna excitation element without being in contact with the antenna excitation element, a parasitic element provided on a surface of a substrate facing the surface of the substrate, and a conductor pattern provided on the surface of the substrate and disposed around the parasitic element without being in contact with the parasitic element, in which the conductor pattern and the conductor pattern are electrically connected to each other, a thickness of the conductor pattern is formed to be equal to or larger than a thickness of the antenna excitation element, and a thickness of the conductor pattern is formed to be equal to or larger than a thickness of the parasitic element.

### CROSS REFERENCE TO RELATED APPLICATIONS

This application is a Continuation of PCT International Application No. PCT/JP2022/006288, filed on Feb. 17, 2022, all of which is hereby expressly incorporated by reference into the present application.

### TECHNICAL FIELD

The present disclosure relates to an antenna device and a method for manufacturing the antenna device.

### BACKGROUND ART

Some antenna devices employ a stacked structure in which an antenna excitation element is provided on a surface of one substrate and a parasitic element is provided on a surface of another substrate. In this antenna device, a gap is provided between the antenna excitation element and the parasitic element for the purpose of, for example, improving gain of the antenna. Such a conventional antenna device is disclosed in, for example, Non Patent Literature 1.

### CITATION LIST

### Non Patent Literature

Non Patent Literature 1: Shunichi Ikeda, “A Circularly Polarized Cavity-Backed Stacked Patch Antenna for Wide-Angle Beam Scanning Millimeter-Wave Phased Array,” 2020 International Symposium on Antennas and Propagation (ISAP), 25-28 Jan. 2021

### SUMMARY OF INVENTION

### Technical Problem

In the antenna device disclosed in Non Patent Literature 1, the substrate on which the antenna excitation element is provided and the substrate on which the parasitic element is provided are separately manufactured. Then, in the antenna device disclosed in Non Patent Literature 1, the two substrates are electrically connected with a spacer interposed between the two substrates, thereby providing a gap between the antenna excitation element and the parasitic element. Thus, there is air between the antenna excitation element and the parasitic element, and the dielectric loss is zero. As a result, the antenna device disclosed in Non Patent Literature 1 achieves high gain and high efficiency of the antenna.

The antenna device disclosed in Non Patent Literature 1 requires the spacer to form the gap between the antenna excitation element and the parasitic element. For example, in a case where such a stacked structure is applied to an antenna device operating in a frequency band of millimeter waves or more, the gap has a height of about several 10 μm. At this time, in order to suppress deterioration of antenna characteristics due to manufacturing tolerance, it is necessary to adjust the gap in units of several μm.

In a case where a substrate is used as the spacer, the thickness of the substrate itself is generally equal to or more than 50 μm, and it is difficult to finely manage the thickness of the substrate. Further, in a case where a metal plate is used as the spacer, it is very difficult to control the thickness of the metal plate by 10 μm.

The present disclosure has been made to solve the above problem, and an object of the present disclosure is to provide an antenna device capable of forming a gap having a predetermined length between an antenna excitation element and a parasitic element without using a spacer.

### Solution to Problem

An antenna device according to the present disclosure includes at least one antenna excitation element provided on a surface of at least one first substrate;
a first conductor pattern provided on the surface of the at least one first substrate and disposed around the at least one antenna excitation element without being in contact with the at least one antenna excitation element; at least one parasitic element provided on a surface of at least one second substrate facing the surface of the at least one first substrate; and a second conductor pattern provided on the surface of the at least one second substrate and disposed around the at least one parasitic element without being in contact with the at least one parasitic element, wherein the first conductor pattern and the second conductor pattern are electrically connected to each other, a thickness of the first conductor pattern is formed to be equal to or larger than a thickness of the at least one antenna excitation element, and a thickness of the second conductor pattern is formed to be equal to or larger than a thickness of the at least one parasitic element.

### Advantageous Effects of Invention

According to the present disclosure, a gap having a predetermined length can be formed between an antenna excitation element and a parasitic element without using a spacer.

### BRIEF DESCRIPTION OF DRAWINGS

FIGS. 1A to 1C are diagrams illustrating a configuration of an antenna device according to a first embodiment. FIG. 1A is a longitudinal sectional view of the antenna device according to the first embodiment. FIG. 1B is a cross-sectional view taken along line I-I in FIG. 1A. FIG. 1C is a cross-sectional view taken along line II-II in FIG. 1A.

FIGS. 2A and 2B are diagrams illustrating a first modification of the antenna device according to the first embodiment. FIG. 2A is a diagram illustrating a modification of an antenna excitation element. FIG. 2B is a diagram illustrating a modification of a parasitic element.

FIG. 3 is a diagram illustrating a second modification of the antenna device according to the first embodiment.

FIG. 4 is a diagram illustrating a third modification of the antenna device according to the first embodiment.

FIGS. 5A to 5C are diagrams illustrating fourth modifications of the antenna device according to the first embodiment.

FIGS. 6A to 6C are diagrams illustrating fifth modifications of the antenna device according to the first embodiment.

FIG. 7 is a diagram illustrating a configuration of an antenna device according to a third embodiment.

FIGS. 8A to 8C are diagrams illustrating a configuration of an antenna device according to a fourth embodiment. FIG. 8A is a longitudinal sectional view of the antenna device according to the first embodiment. FIG. 8B is a cross-sectional view taken along line III-III in FIG. 8A. FIG. 8C is a cross-sectional view taken along line IV-IV in FIG. 8A.

FIG. 9 is a diagram illustrating a modification of the antenna device according to the fourth embodiment.

### DESCRIPTION OF EMBODIMENTS

Hereinafter, in order to describe the present disclosure in more detail, modes for carrying out the present disclosure will be described with reference to the accompanying drawings.

### First Embodiment

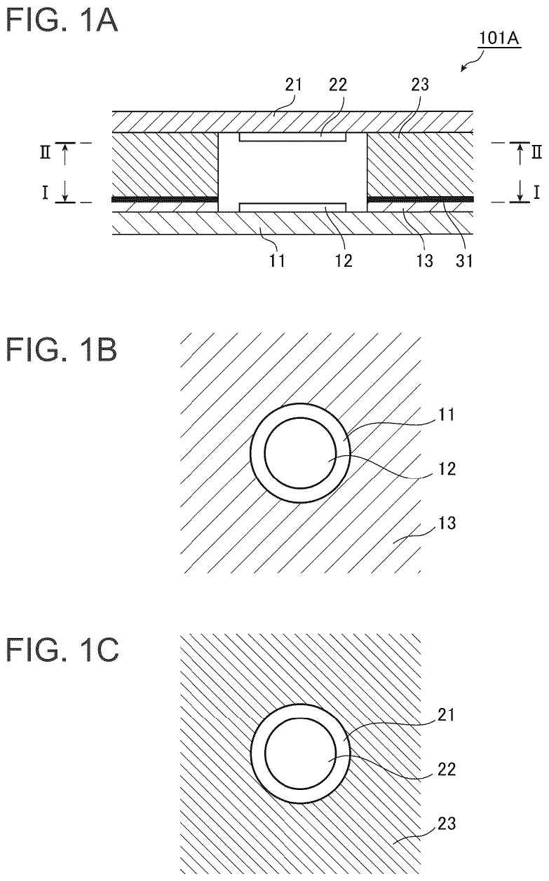

Antenna devices 101A, 101B, 101C, 101D1 to 101D3, and 101E1 to 101E3 according to a first embodiment will be described with reference to FIGS. 1 to 6.

FIGS. 1A to 1C are diagrams illustrating a configuration of the antenna device 101A according to the first embodiment. As illustrated in FIGS. 1A to 1C, the antenna device 101A includes substrates 11 and 21. The substrates 11 and 21 are disposed in such a manner that their surfaces (mounting surfaces) face each other. Note that the substrate 11 constitutes a first substrate, and the substrate 21 constitutes a second substrate.

As illustrated in FIGS. 1A and 1B, the substrate 11 includes one antenna excitation element 12 and one conductor pattern 13. The antenna excitation element 12 and the conductor pattern 13 are provided on the surface of the substrate 11. The conductor pattern 13 constitutes a first conductor pattern and corresponds to a ground conductor. The conductor pattern 13 is, for example, a copper foil.

The antenna excitation element 12 is formed in a circular shape. The conductor pattern 13 is provided so as to surround a periphery of the antenna excitation element 12. The conductor pattern 13 is not in contact with the antenna excitation element 12. That is, an annular gap is formed between the antenna excitation element 12 and the conductor pattern 13. The annular gap is a portion where the surface of the substrate 11 is exposed. Further, a thickness of the antenna excitation element 12 and a thickness of the conductor pattern 13 are the same thicknesses.

As illustrated in FIGS. 1A and 1C, the substrate 21 includes one parasitic element 22 and one conductor pattern 23. The parasitic element 22 and the conductor pattern 23 are provided on the surface of the substrate 21. The conductor pattern 23 constitutes a second conductor pattern and corresponds to a ground conductor. The conductor pattern 23 is, for example, a copper foil.

The parasitic element 22 is formed in a circular shape. The conductor pattern 23 is provided so as to surround a periphery of the parasitic element 22. The conductor pattern 23 is not in contact with the parasitic element 22. That is, an annular gap is formed between the parasitic element 22 and the conductor pattern 23. The annular gap is a portion where the surface of the substrate 21 is exposed. Further, a thickness of the conductor pattern 23 is larger than a thickness of the parasitic element 22.

As illustrated in FIG. 1A, the antenna excitation element 12 provided on the substrate 11 and the parasitic element 22 provided on the substrate 21 face each other. Further, the conductor pattern 13 provided on the substrate 11 and the conductor pattern 23 provided on the substrate 21 are electrically connected via adhesive material 31 having conductivity.

As described above, in the antenna device 101A, the conductor patterns 13 and 23 surround the peripheries of the antenna excitation element 12 and the parasitic element 22 facing each other between the substrates 11 and 21 whose surfaces face each other, thereby forming a hollow structure. Thus, in the antenna device 101A, the antenna excitation element 12 and the parasitic element 22 can be disposed with an interval therebetween. That is, the antenna device 101A can be provided with a gap having a predetermined length between the antenna excitation element 12 and the parasitic element 22 facing each other. Note that the gap is formed at a height equal to or less than 100 μm, for example.

In the conventional antenna device, in a case where a gap having a predetermined length is provided between the antenna excitation element 12 and the parasitic element 22, for example, a spacer needs to be interposed between the substrates 11 and 21. On the other hand, the method for manufacturing the antenna device 101A uses only a process for manufacturing a thick copper substrate. Further, since the antenna device 101A does not require the spacer, the number of components can be reduced. Thus, the antenna device 101A can reduce a mounting tolerance at the time of manufacturing the antenna device 101A by the reduction in the number of components. As a result, the antenna device 101A can suppress degradation of antenna characteristics due to the mounting tolerance.

Furthermore, in the antenna device 101A, the gap formed between the antenna excitation element 12 and the parasitic element 22 can be provided by managing only the thicknesses of the conductor patterns 13 and 23. Specifically, since the antenna device 101A can manage the thicknesses of the conductor patterns 13 and 23 in units of several μm as compared to a case where a spacer as a separate component is used, a gap can be provided between the antenna excitation element 12 and the parasitic element 22 with high accuracy. Thus, the antenna device 101A can improve the degree of freedom in designing the length of the gap formed between the antenna excitation element 12 and parasitic element 22, which can be particularly required in a frequency band of millimeter waves or more, while suppressing degradation of antenna characteristics due to manufacturing tolerances.

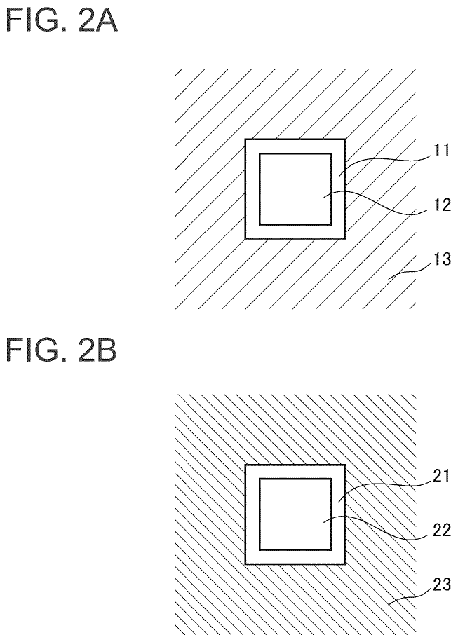

Note that, in the antenna device 101A, the antenna excitation element 12 and the parasitic element 22 are circular, but may be polygonal. Accordingly, FIGS. 2A and 2B are diagrams illustrating another configuration of the antenna device 101A according to the first embodiment. For example, as illustrated in FIGS. 2A and 2B, the antenna excitation element 12 and the parasitic element 22 may have a rectangular shape.

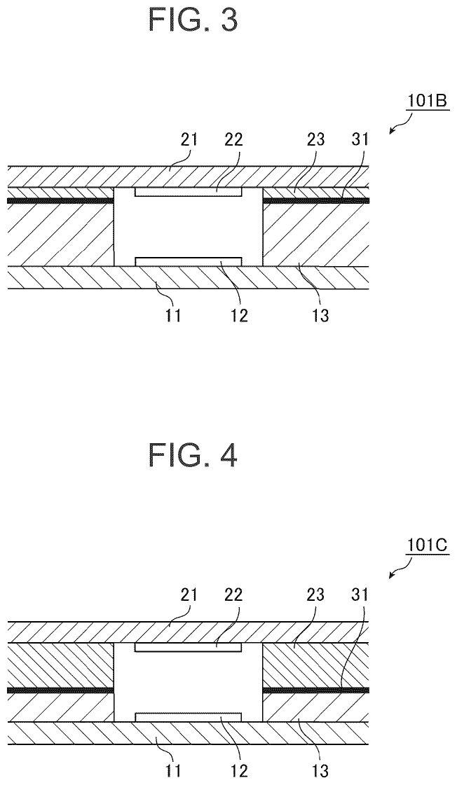

In addition, in the antenna device 101A described above, the thickness of the antenna excitation element 12 and the thickness of the conductor pattern 13 are the same thicknesses and the thickness of the conductor pattern 23 is larger than the thickness of the parasitic element 22, but as long as a gap is formed between the antenna excitation element 12 and the parasitic element 22, the thicknesses of the conductor patterns 13 and 23 may be changed. Accordingly, FIG. 3 is a diagram illustrating a configuration of the antenna device 101B according to the first embodiment. Further, FIG. 4 is a diagram illustrating a configuration of the antenna device 101C according to the first embodiment.

As illustrated in FIG. 3, in the antenna device 101B, the thickness of the conductor pattern 13 is larger than the thickness of the antenna excitation element 12, and the thickness of the parasitic element 22 and the thickness of the conductor pattern 23 are the same thicknesses. Even in a case where such a configuration is employed, the antenna device 101B can provide a gap between the antenna excitation element 12 and the parasitic element 22.

As illustrated in FIG. 4, in the antenna device 101C, the thickness of the conductor pattern 13 is larger than the thickness of the antenna excitation element 12, and the thickness of the conductor pattern 23 is larger than the thickness of the parasitic element 22. Even in a case where such a configuration is employed, the antenna device 101C can provide a gap between the antenna excitation element 12 and the parasitic element 22.

In the antenna devices 101A, 101B, and 101C, at least one of the substrates 11 and 21 is manufactured using a thick copper substrate manufacturing process in order to enable fine management of the thicknesses of the conductor patterns 13 and 23. At this time, thermal diffusion bonding may be applied to electrical connection between the conductor patterns 13 and 23 in a case of improving mountability, highly accurate gap management, and the like. In addition, in a case of reducing the load on the substrates 11 and 21 and reducing the manufacturing cost, solder may be employed for electrical connection between the conductor patterns 13 and 23.

Here, in a case where solder is used as the adhesive material 31 for electrical connection between the conductor patterns 13 and 23, there is a risk that flux as a liquid component contained in the solder may leak from the solder and enter the gap between the antenna excitation element 12 and the parasitic element 22. Thus, original relative permittivity in the gap is “1”, but relative permittivity changes when the flux having different relative permittivity enters the gap. As a result, the resonance frequency changes, and the antenna characteristics deteriorate.

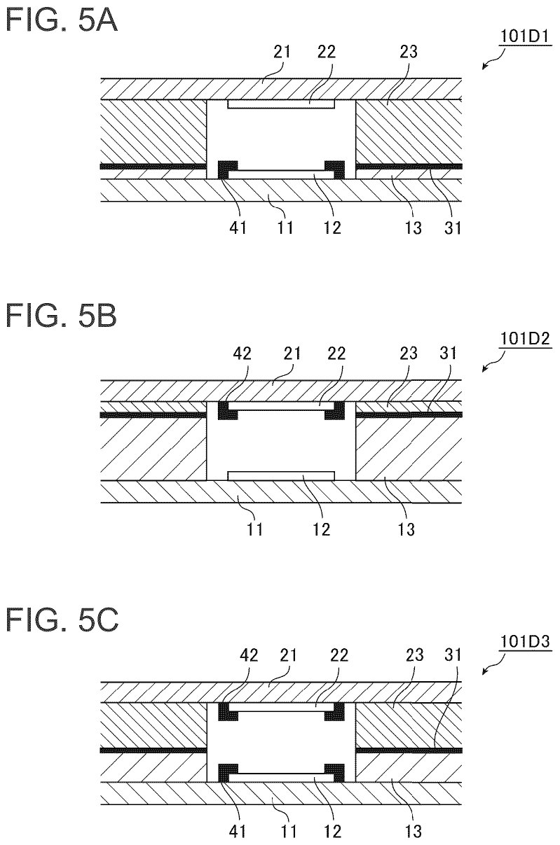

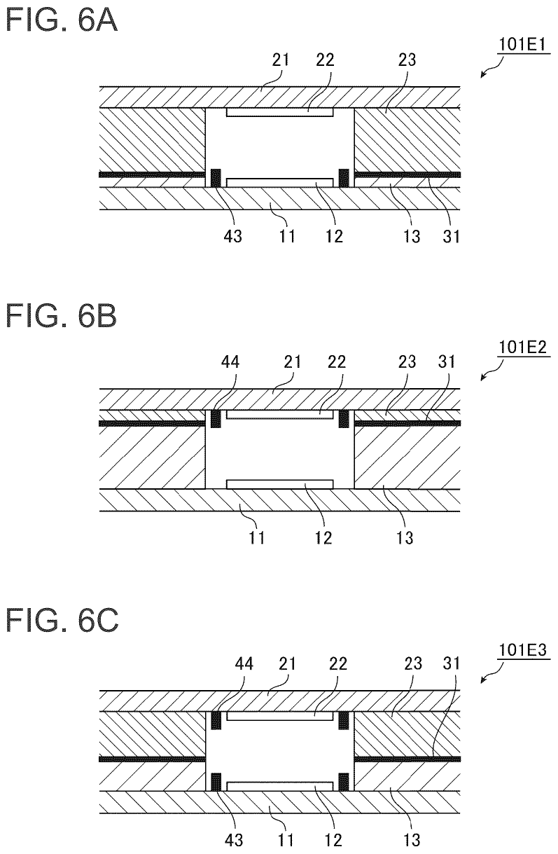

In order to solve such a problem, for example, it is conceivable to employ configurations illustrated in FIGS. 5 and 6.

FIGS. 5A to 5C are diagrams illustrating configurations of the antenna devices 101D1, 101D2, and 101D3 according to the first embodiment.

In the antenna device 101D1 illustrated in FIG. 5A, the thickness of the antenna excitation element 12 and the thickness of the conductor pattern 13 are the same thicknesses, and the thickness of the conductor pattern 23 is larger than the thickness of the parasitic element 22. The antenna device 101D1 includes a resist 41. The resist 41 is provided in contact with an entire outer peripheral portion of the antenna excitation element 12 on the surface of the substrate 11. Specifically, the resist 41 is formed in an annular shape so as to cover an entire surface outer peripheral portion and an entire outer peripheral end surface of the antenna excitation element 12. Thus, the antenna device 101D1 can prevent the flux from entering the gap between the antenna excitation element 12 and the parasitic element 22 from the antenna excitation element 12 side by providing the annular resist 41 on the antenna excitation element 12.

In the antenna device 101D2 illustrated in FIG. 5B, the thickness of the conductor pattern 13 is larger than the thickness of the antenna excitation element 12, and the thickness of the parasitic element 22 and the thickness of the conductor pattern 23 are the same thicknesses. The antenna device 101D2 includes a resist 42. The resist 42 is provided in contact with an entire outer peripheral portion of the parasitic element 22 on the surface of the substrate 21. Specifically, the resist 42 is formed in an annular shape so as to cover an entire surface outer peripheral portion and an entire outer peripheral end surface of the parasitic element 22. Thus, the antenna device 101D2 can prevent the flux from entering the gap between the antenna excitation element 12 and the parasitic element 22 from the parasitic element 22 side by providing the annular resist 42 on the parasitic element 22.

In the antenna device 101D3 illustrated in FIG. 5C, the thickness of the conductor pattern 13 is larger than the thickness of the antenna excitation element 12, and the thickness of the conductor pattern 23 is larger than the thickness of the parasitic element 22. The antenna device 101D3 includes the resists 41 and 42. Thus, by providing the resists 41 and 42, the antenna device 101D3 can prevent the flux from entering the gap between the antenna excitation element 12 and the parasitic element 22.

Further, FIGS. 6A to 6C are diagrams illustrating configurations of the antenna devices 101E1, 101E2, and 101E3 according to the first embodiment.

In the antenna device 101E1 illustrated in FIG. 6A, the thickness of the antenna excitation element 12 and the thickness of the conductor pattern 13 are the same thicknesses, and the thickness of the conductor pattern 23 is larger than the thickness of the parasitic element 22. The antenna device 101E1 includes a resist 43. The resist 43 is formed in an annular shape on the surface of the substrate 11 so as to surround the entire circumference of the antenna excitation element 12. Further, a thickness (height) of the resist 43 is larger than the thickness of the antenna excitation element 12. Thus, the antenna device 101E1 can prevent the flux from entering the gap between the antenna excitation element 12 and the parasitic element 22 from the antenna excitation element 12 side by providing the annular resist 43 around the antenna excitation element 12.

In the antenna device 101E2 illustrated in FIG. 6B, the thickness of the conductor pattern 13 is larger than the thickness of the antenna excitation element 12, and the thickness of the parasitic element 22 and the thickness of the conductor pattern 23 are the same thicknesses. The antenna device 101E2 includes a resist 44. The resist 44 is formed in an annular shape on the surface of the substrate 21 so as to surround the entire circumference of the parasitic element 22. Further, a thickness (height) of the resist 44 is larger than the thickness of the parasitic element 22. Thus, the antenna device 101E2 can prevent the flux from entering the gap between the antenna excitation element 12 and the parasitic element 22 from the parasitic element 22 side by providing the annular resist 44 around the parasitic element 22.

In the antenna device 101E3 illustrated in FIG. 6C, the thickness of the conductor pattern 13 is larger than the thickness of the antenna excitation element 12, and the thickness of the conductor pattern 23 is larger than the thickness of the parasitic element 22. The antenna device 101E3 includes the resists 43 and 44. Thus, by providing the resists 43 and 44, the antenna device 101E3 can prevent the flux from entering the gap between the antenna excitation element 12 and the parasitic element 22.

Here, the base material of the substrates 11 and 21 only needs to be a dielectric, and is, for example, a resin material, glass, or the like. In a case where a resin material is employed as the base material of the substrates 11 and 21, the antenna device 101A can suppress the manufacturing cost. Further, in a case where glass is employed as the base material of the substrates 11 and 21, the antenna device 101A can achieve low loss and high gain of the antenna.

Note that the thickness of the conductor pattern 13 only needs to be equal to or larger than the thickness of the antenna excitation element 12, and the thickness of the conductor pattern 23 only needs to be equal to or larger than the thickness of the parasitic element 22.

As described above, the antenna devices 101A, 101B, 101C, 101D1 to 101D3, and 101E1 to 101E3 according to the first embodiment each include the antenna excitation element 12 provided on the surface of the substrate 11, the conductor pattern 13 provided on the surface of the substrate 11 and disposed around the antenna excitation element 12 without being in contact with the antenna excitation element 12, the parasitic element 22 provided on the surface of the substrate 21 facing the surface of the substrate 11, and the conductor pattern 23 provided on the surface of the substrate 21 and disposed around the parasitic element 22 without being in contact with the parasitic element 22, in which the conductor pattern 13 and the conductor pattern 23 are electrically connected, the thickness of the conductor pattern 13 is formed to be equal to or larger than the thickness of the antenna excitation element 12, and the thickness of the conductor pattern 23 is formed to be equal to or larger than the thickness of the parasitic element 22. Thus, in the antenna devices 101A, 101B, 101C, 101D1 to 101D3, and 101E1 to 101E3, a gap having a predetermined length can be formed between the antenna excitation element 12 and the parasitic element 22 without using a spacer.

In the antenna devices 101A, 101D1, and 101E1, the thickness of the conductor pattern 13 is formed to be the same as the thickness of the antenna excitation element 12, and the thickness of the conductor pattern 23 is formed to be larger than the thickness of the parasitic element 22. Thus, in the antenna devices 101A, 101B, 101C, 101D1 to 101D3, and 101E1 to 101E3, a gap having a predetermined length can be formed between the antenna excitation element 12 and the parasitic element 22 without using a spacer.

In the antenna devices 101B, 101D2, and 101E2, the thickness of the conductor pattern 13 is formed to be larger than the thickness of the antenna excitation element 12, and the thickness of the conductor pattern 23 is formed to be the same as the thickness of the parasitic element 22. Thus, in the antenna devices 101A, 101B, 101C, 101D1 to 101D3, and 101E1 to 101E3, a gap having a predetermined length can be formed between the antenna excitation element 12 and the parasitic element 22 without using a spacer.

In the antenna devices 101C, 101D3, and 101E3, the thickness of the conductor pattern 13 is formed to be larger than the thickness of the antenna excitation element 12, and the thickness of the conductor pattern 23 is formed to be larger than the thickness of the parasitic element 22. Thus, in the antenna devices 101A, 101B, 101C, 101D1 to 101D3, and 101E1 to 101E3, a gap having a predetermined length can be formed between the antenna excitation element 12 and the parasitic element 22 without using a spacer.

In the antenna devices 101A, 101B, 101C, 101D1 to 101D3, and 101E1 to 101E3, at least one of the substrate 11 or the substrate 21 is formed using a process of manufacturing a thick copper substrate. Thus, in the antenna devices 101A, 101B, 101C, 101D1 to 101D3, and 101E1 to 101E3, at least one of the substrate 11 or the substrate 21 can be manufactured with high accuracy.

In the antenna devices 101A, 101B, 101C, 101D1 to 101D3, and 101E1 to 101E3, the conductor pattern 13 and the conductor pattern 23 are connected using the adhesive material 31 having conductivity. Thus, in the antenna devices 101A, 101B, 101C, 101D1 to 101D3, and 101E1 to 101E3, the conductor patterns 13 and 23 can be easily electrically connected.

The antenna devices 101D1 to 101D3 and 101E1 to 101E3 each include the resist 41 to 44 provided around at least one of the antenna excitation element 12 or the parasitic element 22. Thus, in a case where the adhesive material 31 is solder, the antenna devices 101D1 to 101D3 and 101E1 to 101E3 can prevent the flux from entering the gap between the antenna excitation element 12 and the parasitic element 22.

In the antenna devices 101A, 101B, 101C, 101D1 to 101D3, and 101E1 to 101E3, the conductor pattern 13 and the conductor pattern 23 are connected by thermal diffusion bonding. Thus, in the antenna devices 101A, 101B, 101C, 101D1 to 101D3, and 101E1 to 101E3, the conductor patterns 13 and 23 can be easily electrically connected.

In the antenna devices 101A, 101B, 101C, 101D1 to 101D3, and 101E1 to 101E3, the substrate 11 and the substrate 21 are formed by a dielectric made of a resin material or glass. Thus, in a case where a resin material is employed as the base material of the substrates 11 and 21, the antenna devices 101A, 101B, 101C, 101D1 to 101D3, and 101E1 to 101E3 can suppress the manufacturing cost. Further, in a case where glass is employed as the base material of the substrates 11 and 21, the antenna devices 101A, 101B, 101C, 101D1 to 101D3, and 101E1 to 101E3 can achieve low loss and high gain of the antenna.

In the antenna devices 101A, 101B, 101C, 101D1 to 101D3, and 101E1 to 101E3, the gap formed between the antenna excitation element 12 and the parasitic element 22 is formed to have a length equal to or less than 100 μm. Thus, the antenna devices 101A, 101B, 101C, 101D1 to 101D3, and 101E1 to 101E3 can be applied as an antenna device that operates in a frequency band of millimeter waves or more.

### Second Embodiment

An antenna device according to a second embodiment will be described. Note that configurations having functions similar to those described in the first embodiment described above are denoted by the same reference numerals, and description thereof will be omitted.

The antenna device according to the second embodiment particularly operates at a frequency of a millimeter wave or more, in particular, in a sub-terahertz band and a terahertz band. The basic configuration of the antenna device according to the second embodiment is the same as the basic configuration of the antenna device 101A according to the first embodiment.

In the antenna device according to the second embodiment, the substrate 11 includes a semiconductor substrate such as an integrated circuit (IC), and the substrate 21 includes a dielectric substrate such as a resin substrate.

The antenna device according to the second embodiment is what is called an on-chip antenna. In the method for manufacturing the antenna device, since the substrate 11 is a semiconductor substrate, a semiconductor manufacturing process applied to an IC or the like is applied. A semiconductor manufacturing process is known as a highly accurate manufacturing process. While a minimum line width and manufacturing tolerances of the conductor patterns 13 and 23 are several 10 μm in the manufacturing process of the thick copper substrate described in the first embodiment, they are about several μm in the manufacturing process of the semiconductor. While the semiconductor manufacturing process is an expensive manufacturing process, the antenna device can be manufactured with higher accuracy. For this reason, in the antenna device manufactured using the semiconductor manufacturing process, manufacturing tolerances on the substrates 11 and 21 can be reduced, so that the degradation of the antenna characteristics can be suppressed.

The antenna device according to the second embodiment is different from the antenna devices 101A, 101B, and 101C according to the first embodiment in that the antenna excitation element 12 can be provided on an IC. Thus, the antenna device according to the second embodiment does not require a connection configuration in which, for example, an IC constituting an active circuit such as an amplifier and a mixer and the substrates 11 and 21 on which passive circuits such as an antenna element, an antenna feed line, and a filter are formed are connected using wire bonding, flip-chip mounting, or the like. As a result, the antenna device according to the second embodiment can suppress the influence of the loss and the parasitic component generated when the IC and the substrates 11 and 21 are connected, and can improve efficiency and gain of the antenna.

Further, similarly to the antenna device 101A according to the first embodiment, the antenna device according to the second embodiment can provide a gap between the antenna excitation element 12 and the parasitic element 22. At this time, since the antenna device according to the second embodiment does not use a spacer that is a separate member, deterioration of antenna characteristics can be suppressed from the viewpoint of mountability, manufacturability, and physical properties.

Therefore, the antenna device according to the second embodiment can provide a gap between the antenna excitation element 12 and the parasitic element 22 without using a separate spacer. Thus, the antenna device according to the second embodiment can improve mountability by reducing the number of components. Further, since the antenna device according to the second embodiment employs the semiconductor manufacturing process, manufacturing accuracy and mounting accuracy can be further improved. Thus, the antenna device according to the second embodiment can easily have antenna characteristics that can be required in a frequency band of millimeter waves or more.

As described above, in the antenna device according to the second embodiment, the substrate 11 and the substrate 21 are formed by a semiconductor substrate. Thus, the antenna device according to the second embodiment can reduce the manufacturing tolerances on the substrates 11 and 21, and thus can suppress deterioration of antenna characteristics.

### Third Embodiment

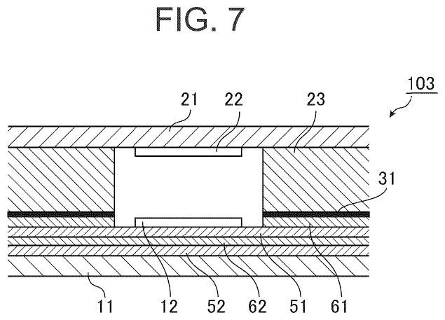

An antenna device 103 according to a third embodiment will be described with reference to FIG. 7. FIG. 7 is a diagram illustrating a configuration of the antenna device 103 according to the third embodiment. Note that configurations having functions similar to those described in the first embodiment described above are denoted by the same reference numerals, and description thereof will be omitted.

The antenna device 103 according to the third embodiment has a configuration in which a plurality of insulating layers 51 and 52 and a plurality of conductor layers 61 and 62 are provided by using a rewiring process which is a post-process process of an IC with respect to the antenna device according to the second embodiment. FIG. 7 illustrates an example in which the antenna device 103 includes two insulating layers 51 and 52 and two conductor layers 61 and 62.

Note that the insulating layers 51 and 52 are formed of, for example, a resin material such as polyimide, and constitute a dielectric. Further, the conductor layers 61 and 62 are formed of a metal material having high conductivity such as copper.

On the surface of the substrate 11, the insulating layer 52, the conductor layer 62, the insulating layer 51, and the conductor layer 61 are stacked in this order. Specifically, the insulating layer 52 is provided on the surface of the substrate 11. The conductor layer 62 is provided on a surface of the insulating layer 52. The insulating layer 51 is provided on a surface of the conductor layer 62. The conductor layer 61 is provided on a surface of the insulating layer 51. The conductor layer 61 is electrically connected to the conductor pattern 23 via the adhesive material 31.

That is, in the antenna device 103, the plurality of insulating layers 51 and 52 and the plurality of conductor layers 61 and 62 are alternately stacked on the surface of the substrate 11, and the uppermost conductor layer 61 serving as a first conductor pattern is electrically connected to the conductor pattern 23 serving as a second conductor pattern. At this time, in the antenna device 103, the thickness of the antenna excitation element 12 and a thickness of the conductor layer 61 are the same thicknesses, and the thickness of the conductor pattern 23 is larger than the thickness of the parasitic element 22.

The antenna device 103 is a semiconductor manufacturing process applied to an IC or the like, and has a configuration in which two or more insulating layers 51 and 52 are formed by a rewiring process to be a subsequent process, and two or more conductor layers 61 and 62 are formed on each upper layer thereof. As described above, since the antenna device 103 includes the insulating layers 51 and 52 and the conductor layers 61 and 62, a highly accurate semiconductor manufacturing process can be applied, so that manufacturing accuracy of the antenna device 103 can be improved.

Further, in the antenna device according to the second embodiment, the antenna excitation element 12 is provided on the surface of the substrate 11 made of a semiconductor. On the other hand, in the antenna device 103, the antenna excitation element 12 is provided on the surface of the insulating layer 51 including a dielectric. In general, a semiconductor substrate formed of Si or the like has a large loss, and thus antenna characteristics tend to deteriorate. On the other hand, a resin material such as polyimide has a lower loss than a semiconductor. Thus, the antenna device 103 can suppress deterioration of antenna characteristics by applying the rewiring process.

Furthermore, since the base plate of the antenna excitation element 12 is the conductor layer 62 of the rewiring layer in the antenna device 103, the antenna excitation element 12 can be separated from an amplifier, passive circuits such as a mixer, passive circuits such as a filter, a feed line to the antenna, and the like provided on the substrate 11. Thus, the antenna device 103 can suppress electrical interference between the antenna excitation element 12 and the circuits provided on the substrate 11. Further, since the antenna device 103 can separate the antenna excitation element 12 from the substrate 11, it is possible to reduce the density and size of the substrate 11.

Therefore, the antenna device 103 can provide a gap between the antenna excitation element 12 and the parasitic element 22 without using a separate spacer. Thus, the antenna device 103 can improve mountability by reducing the number of components. Further, since the antenna device 103 employs the semiconductor manufacturing process, the manufacturing accuracy and the mounting accuracy can be further improved. Thus, the antenna device 103 can easily have antenna characteristics that can be required in a frequency band of millimeter waves or more. Furthermore, the antenna device 103 can separate the antenna excitation element 12 from the substrate 11 by including the plurality of insulating layers 51 and 52 and the plurality of conductor layers 61 and 62. Thus, the antenna device 103 can reduce the density and size of the substrate 11.

As described above, in the antenna device 103 according to the third embodiment, the plurality of insulating layers 51 and 52 and the plurality of conductor layers 61 and 62 are alternately stacked on the surface of the substrate 11, and the uppermost conductor layer 61 is electrically connected to the conductor pattern 23. Thus, the antenna device 103 can separate the antenna excitation element 12 from the substrate 11. As a result, the antenna device 103 can achieve reduction in density and size of the substrate 11.

### Fourth Embodiment

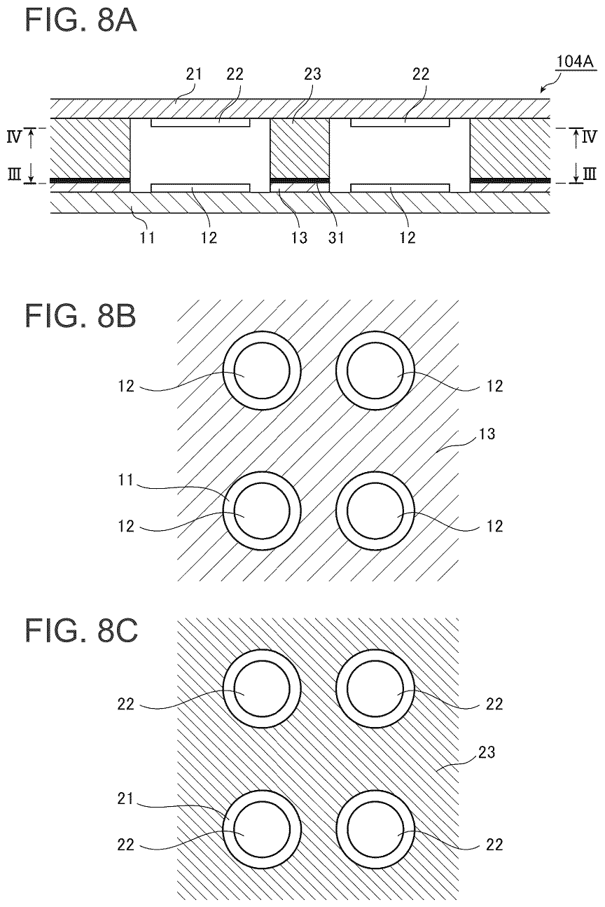

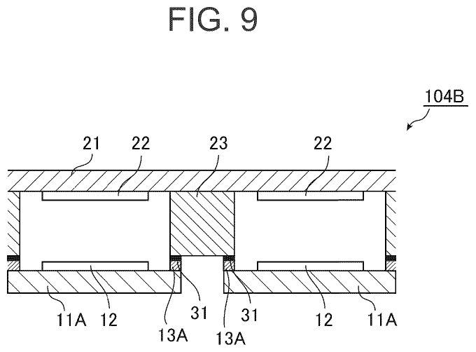

Antenna devices 104A and 104B according to a fourth embodiment will be described with reference to FIGS. 8 and 9. Note that configurations having functions similar to those described in the first embodiment described above are denoted by the same reference numerals, and description thereof will be omitted.

FIGS. 8A to 8C are diagrams illustrating a configuration of the antenna device 104A according to the fourth embodiment. FIGS. 8A to 8C illustrate an example in which the antenna device 104A includes a plurality of antenna excitation elements 12 and a plurality of parasitic elements 22. The antenna device 104A includes, for example, four antenna excitation elements 12 and four parasitic elements 22.

As illustrated in FIGS. 8A and 8B, the antenna excitation elements 12 are each formed in a circular shape. The conductor pattern 13 is provided so as to surround a periphery of the antenna excitation element 12. The conductor pattern 13 is not in contact with the antenna excitation element 12. That is, an annular gap is formed between the antenna excitation element 12 and the conductor pattern 13. The annular gap is a portion where the surface of the substrate 11 is exposed. Further, a thickness of the antenna excitation element 12 and a thickness of the conductor pattern 13 are the same thicknesses.

As illustrated in FIGS. 8A and 8C, the parasitic elements 22 are each formed in a circular shape. The conductor pattern 23 is provided so as to surround a periphery of the parasitic element 22. The conductor pattern 23 is not in contact with the parasitic element 22. That is, an annular gap is formed between the parasitic element 22 and the conductor pattern 23. The annular gap is a portion where the surface of the substrate 21 is exposed. Further, a thickness of the conductor pattern 23 is larger than a thickness of the parasitic element 22.

As illustrated in FIG. 8A, the antenna excitation elements 12 provided on the substrate 11 and the parasitic elements 22 provided on the substrate 21 face each other. Further, the conductor pattern 13 provided on the substrate 11 and the conductor pattern 23 provided on the substrate 21 are electrically connected via adhesive material 31 having conductivity.

As described above, in the antenna device 104A, the conductor patterns 13 and 23 surround the peripheries of the four antenna excitation elements 12 and the four parasitic elements 22 facing each other between the substrates 11 and 21 whose surfaces face each other, thereby forming four hollow structures. Thus, in the antenna device 101A, the antenna excitation element 12 and the parasitic element 22 can be disposed with an interval therebetween. That is, the antenna device 101A can be provided with a gap having a predetermined length between the antenna excitation element 12 and the parasitic element 22 facing each other.

The antenna device 104A is what is called an array antenna device. Since the antenna device 104A includes the plurality of antenna excitation elements 12 and the plurality of parasitic elements 22, the antenna device can have high functions such as high gain and improvement in directivity. Thus, the antenna device 104A can transmit desired power in a desired direction. Further, the antenna device 104A can receive desired power from a desired direction.

Therefore, the antenna device 104A can provide a gap between the antenna excitation element 12 and the parasitic element 22 without using a separate spacer. Thus, the antenna device 104A can improve mountability by reducing the number of components. Further, since the antenna device 103 employs the semiconductor manufacturing process, the manufacturing accuracy and the mounting accuracy can be further improved. Thus, the antenna device 104A can easily have antenna characteristics that can be required in a frequency band of millimeter waves or more. Furthermore, since the antenna device 104A includes the plurality of antenna excitation elements 12 and the plurality of parasitic elements 22, gain as an array antenna device can be improved.

Note that the distance between the antenna excitation elements 12 and the distance between the parasitic elements 22 only needs to be equal to or more than ½ wavelength and equal to or less than 1 wavelength. In addition, although the antenna excitation elements 12 and the parasitic elements 22 facing each other are arranged in a quadrangular array, the arrangement may be appropriately adjusted according to the number.

Furthermore, although the antenna device 104A includes the plurality of antenna excitation elements 12 on the surface of one substrate 11 and the plurality of parasitic elements 22 on the surface of one substrate 21, the antenna device is not limited to this configuration in a case of including the plurality of antenna excitation elements 12 and the plurality of parasitic elements 22. For example, as the array antenna device, the configuration illustrated in FIG. 9 may be employed in order to improve the yield of the antenna excitation element 12 and the parasitic element 22.

FIG. 9 is a diagram illustrating a configuration of the antenna device 104B according to the fourth embodiment. As illustrated in FIG. 9, the antenna device 104B includes a plurality of substrates 11 each including one antenna excitation element 12, and one substrate 21 each including a plurality of parasitic elements 22. Note that the antenna device 104B may include one substrate 11 including a plurality of antenna excitation elements 12 and a plurality of substrates 21 each including one parasitic element 22.

As described above, the antenna device 104A according to the fourth embodiment includes the plurality of antenna excitation elements 12 provided on the surface of the substrate 11, the conductor pattern 13 provided on the surface of the substrate 11 and disposed around each of the antenna excitation elements 12 without being in contact with the each of the antenna excitation elements 12, the plurality of parasitic elements 22 provided on the surface of the substrate 21 facing the surface of the substrate 11, and the conductor pattern 23 provided on the surface of the substrate 21 and disposed around each of the parasitic elements 22 without being in contact with the each of the parasitic elements 22, in which the conductor pattern 13 and conductor pattern 23 are electrically connected to each other, the thickness of the conductor pattern 13 is formed to be equal to or larger than the thickness of the antenna excitation element 12, and the thickness of the conductor pattern 23 is formed to be equal to or larger than the thickness of the parasitic element 22. Thus, the antenna device 104A can form a gap having a predetermined length between the antenna excitation elements 12 and the parasitic elements 22 without using a spacer.

The antenna device 104B includes a plurality of substrates 11 each including one antenna excitation element 12 and one substrate 21 including a plurality of parasitic elements 22. Thus, the antenna device 104B can improve the yield of the antenna excitation element 12 and the parasitic element 22 as an array antenna device.

Further, the antenna device 104B includes one substrate 11 including a plurality of antenna excitation elements 12 and a plurality of substrates 21 each including one parasitic element 22. Thus, the antenna device 104B can improve the yield of the antenna excitation element 12 and the parasitic element 22 as an array antenna device.

Note that, in the present disclosure, free combinations of the embodiments, modifications of any components of the embodiments, or omissions of any components in the embodiments are possible within the scope of the disclosure.

### INDUSTRIAL APPLICABILITY

In an antenna device according to the present disclosure, a thickness of a first conductor pattern is equal to or larger than a thickness of an antenna excitation element, and a thickness of a second conductor pattern is equal to or larger than a thickness of the parasitic element, so that a gap having a predetermined length can be formed between the antenna excitation element and the parasitic element, and the antenna device is suitable for use in an antenna device or the like.

### REFERENCE SIGNS LIST

11, 21: substrate, 12: antenna excitation element, 13, 23: conductor pattern, 22: parasitic element, 31: adhesive material, 41 to 44: resist, 51, 52: insulating layer, 61, 62: conductor layer, 101A, 101B, 101C, 101D1 to 101D3, 101E1 to 101E3, 103, 104A, 104B: antenna device

1. An antenna device comprising:
at least one antenna excitation element provided on a surface of at least one first substrate;
a first conductor pattern provided on the surface of the at least one first substrate and disposed around the at least one antenna excitation element without being in contact with the at least one antenna excitation element;
at least one parasitic element provided on a surface of at least one second substrate facing the surface of the at least one first substrate; and
a second conductor pattern provided on the surface of the at least one second substrate and disposed around the at least one parasitic element without being in contact with the at least one parasitic element, wherein
the first conductor pattern and the second conductor pattern are electrically connected to each other,
a thickness of the first conductor pattern is formed to be equal to or larger than a thickness of the at least one antenna excitation element, and
a thickness of the second conductor pattern is formed to be equal to or larger than a thickness of the at least one parasitic element.

2. The antenna device according to claim 1, wherein
a thickness of the first conductor pattern is formed to be same as a thickness of the at least one antenna excitation element, and
a thickness of the second conductor pattern is formed to be larger than a thickness of the at least one parasitic element.

3. The antenna device according to claim 1, wherein
a thickness of the first conductor pattern is formed to be larger than a thickness of the at least one antenna excitation element, and
a thickness of the second conductor pattern is formed to be same as a thickness of the at least one parasitic element.

4. The antenna device according to claim 1, wherein
a thickness of the first conductor pattern is formed to be larger than a thickness of the at least one antenna excitation element, and
a thickness of the second conductor pattern is formed to be larger than a thickness of the at least one parasitic element.

5. The antenna device according to claim 1, wherein
at least one of the at least one first substrate or the at least one second substrate is formed using a process of manufacturing a thick copper substrate.

6. The antenna device according to claim 1, wherein
the first conductor pattern and the second conductor pattern are connected using adhesive material having conductivity.

7. The antenna device according to claim 6, further comprising:
a resist provided around at least one of the at least one antenna excitation element or the at least one parasitic element.

8. The antenna device according to claim 1, wherein
the first conductor pattern and the second conductor pattern are connected by thermal diffusion bonding.

9. The antenna device according to claim 1, wherein
the at least one first substrate and the at least one second substrate are formed by a dielectric made of a resin material or glass.

10. The antenna device according to claim 1, wherein
each of the at least one first substrate and the at least one second substrate are formed by a semiconductor substrate.

11. The antenna device according to claim 1, wherein
a plurality of insulating layers and a plurality of conductor layers are alternately stacked on a surface of the at least one first substrate, and
an uppermost conductor layer among the plurality of insulating layers and the plurality of conductor layers is electrically connected to the second conductor pattern as the first conductor pattern.

12. The antenna device according to claim 1, wherein
the at least one first substrate includes a plurality of first substrates each provided with the at least one antenna excitation element, and the at least one second substrate includes a second substrate provided with a plurality of parasitic elements included in the at least one parasitic element.

13. The antenna device according to claim 1, wherein
the at least one first substrate includes one first substrate provided with a plurality of antenna excitation elements included in the at least one antenna excitation element, and the at least one second substrate includes a plurality of second substrates each provided with a parasitic element included in the at least one parasitic element.

14. The antenna device according to claim 1, wherein
a gap formed between the at least one antenna excitation element and the at least one parasitic element is formed to have a length equal to or less than 100 μm.

15. A method for manufacturing an antenna device, wherein
the antenna device comprises:
at least one antenna excitation element provided on a surface of at least one first substrate;
a first conductor pattern provided on the surface of the at least one first substrate and disposed around the at least one antenna excitation element without being in contact with the at least one antenna excitation element;
at least one parasitic element provided on a surface of at least one second substrate facing the surface of the at least one first substrate; and
a second conductor pattern provided on the surface of the at least one second substrate and disposed around the at least one parasitic element without being in contact with the at least one parasitic element,
wherein the method comprises: forming a thickness of the first conductor pattern to be equal to or larger than a thickness of the at least one antenna excitation element;
forming a thickness of the second conductor pattern to be equal to or larger than a thickness of the at least one parasitic element; and
electrically connecting the first conductor pattern and the second conductor pattern to each other.
